(19) United States
(12) Patent Application Publication
(10) Pub. No.: US 2014/0037795 A1
(43) Pub. Date: Feb. 6, 2014

(54) FISH FOOD WITH INCREASED BUOYANCY

(71) Applicant: Omega Sea, LLC, Painesville, OH (US)

(72) Inventor: Dennis G. Crews, Concord, OH (US)

(73) Assignee: OMEGA SEA, LLC, Painesville, OH (US)

(21) Appl. No.: 13/960,442

(22) Filed: Aug. 6, 2013

Related U.S. Application Data
(60) Provisional application No. 61/680,186, filed on Aug. 6, 2012.

(51) Int. Cl. A23K 1/18

(52) U.S. Cl. CPC A23K 1/188
USPC 426/72; 426/573; 426/531; 426/574; 426/643; 426/519

(57) ABSTRACT

Disclosed herein are frozen and/or gelled fish food products having an increased buoyancy. The frozen and/or gelled fish food products include a food component comprising a frozen and/or gelled fish food composition that encompasses at least one air cavity. The overall density of the food product is less than or equal to the density of feeding water in which it is placed. Also disclosed herein are methods and apparatuses for preparing such frozen and/or gelled fish food products.

### RELATED APPLICATION

This application is a U.S. Non-Provisional Patent Application which claims priority to U.S. Provisional Patent Application Ser. No. 61/680,186, filed on Aug. 6, 2012 and titled “FISH FOOD WITH INCREASED BUOYANCY,” which is hereby incorporated by reference in its entirety.

### FIELD OF THE INVENTION

This disclosure relates to frozen and/or gelled fish food products having increased buoyancy. This disclosure also relates to methods and apparatuses for producing such frozen and/or gelled fish food products having increased buoyancy.

### BACKGROUND

Frozen fish foods are a useful way to deliver fresh, perishable foods to fish contained in aquariums, tanks, ponds or other enclosures. The frozen fish foods can contribute to the health and well being of the fish by providing nutrients that may not be found in the more common dry fish food flakes, pellets, or tablets. The frozen fish foods also can contribute to the health and well being of fish by providing food for fish that do not readily take to dry foods and also by providing variety to the diet of the fish.

Frozen fish foods that exclusively contain fresh or perishable foods typically do not float and will sink to the bottom, or close to the bottom, of the aquarium or pond housing the fish. This may be problematic for fish that are not willing or able to eat the food near the bottom, or off of the bottom of the aquarium or pond.

Disclosed herein are exemplary embodiments of frozen and/or gelled fish food products, as well as exemplary methods and apparatuses for making such products, that exhibit an increased buoyancy when added to the feeding water containing the fish.

### SUMMARY OF THE INVENTION

In accordance with exemplary embodiments of the present disclosure, frozen and/or gelled fish food products having an increased buoyancy, are disclosed herein. The frozen and/or gelled fish food products contain at least one air cavity that lowers the overall density of the food product and provides buoyancy when the frozen and/or gelled products are placed in the feeding water.

In accordance with one exemplary embodiment, a fish food product having an increased buoyancy is provided. The fish food product includes a fish food composition that encompasses at least one air cavity. The fish food composition is selected from a frozen fish food composition, a gelled fish food composition, and combinations thereof. The overall density of the exemplary fish food product is less than or equal to the density of feeding water.

In accordance with another exemplary embodiment, a method for preparing a frozen fish food product having an increased buoyancy is provided. In accordance with the exemplary method, a fish food composition is inserted into a sealable compartment of a cooling container in an amount that does not fill the entire volume of the at least one sealable compartment. The fish food composition is selected from a liquid fish food composition, at least a partially gelled fish food composition, and combinations thereof. The sealable compartment is concurrently cooled and tumbled until the fish food composition freezes to form a frozen fish food product with the frozen fish food composition encompassing at least one air cavity. The overall density of the exemplary frozen fish food product is less than or equal to the density of feeding water.

In accordance with another exemplary embodiment, a method for preparing a gelled fish food product having an increased buoyancy is provided. In accordance with the exemplary method, a fish food composition is inserted into a sealable compartment of a cooling container in an amount that does not fill the entire volume of the at least one sealable compartment. The fish food composition is selected from a liquid fish food composition, at least a partially gelled fish food composition, and combinations thereof. The sealable compartment is concurrently cooled and tumbled until the fish food composition gels to form a gelled fish food product with the gelled fish food composition encompassing at least one air cavity. The overall density of the exemplary gelled fish food product is less than or equal to the density of feeding water. In accordance with additional exemplary embodiments, apparatuses for preparing frozen and/or gelled fish food products having an increased buoyancy are provided.

Various exemplary features and advantages of the general inventive concepts will be set forth in part in the description which follows, and in part will be obvious from the description, or may be readily learned by practice of the general inventive concepts. The accompanying drawings, which are incorporated in and constitute a part of the instant application, illustrate one or more embodiments exemplifying the general inventive concepts, and together with the description, serve to explain the principles of the general inventive concepts.

### BRIEF DESCRIPTION OF THE DRAWINGS

FIG. 1 shows a cross-sectional view of one exemplary, non-limiting embodiment of a frozen and/or gelled fish food product; and

FIG. 2 shows a schematic view of one exemplary, non-limiting embodiment of an apparatus for use in producing a frozen and/or gelled fish food product.

### DETAILED DESCRIPTION

The present invention will now be described with occasional reference to specific embodiments of the invention. This invention may, however, be embodied in different forms and should not be construed as limited to the embodiments set forth herein. Rather, these embodiments are provided so that this disclosure will fully convey the scope of the invention to those skilled in the art and are not intended to limit the scope of the invention in any way.

Except as otherwise specifically defined herein, all terms used herein have the same meaning as commonly understood by one of ordinary skill in the art to which this invention belongs. The terminology used in the description of the invention herein is for describing particular embodiments only, and is not intended to be limiting of the invention. As used in the description of the invention, the singular forms “a,” “an,” and “the” are intended to include the plural forms as well, unless the context clearly indicates otherwise.

Unless otherwise indicated, all numbers expressing quantities, properties, and so forth as used in the specification are to be understood as being modified in all instances by the term “about.” Accordingly, unless otherwise indicated, the numerical properties set forth in the following specification are approximations that may vary depending on the desired properties sought to be obtained in embodiments of the present invention. Notwithstanding that the numerical ranges and parameters setting forth the broad scope of the invention are approximations, the numerical values to the extent that such are set forth in the specific examples are reported as precisely as possible. Any numerical values, however, inherently contain certain errors necessarily resulting from error found in their respective measurements.

As used herein, “feeding water” refers to the water in which the frozen and/or gelled fish food product is placed and includes any water in which the captive fish that eat the frozen and/or gelled fish food product are contained. Examples of feeding water include, but are not limited to, water in aquariums e.g., home aquariums, public aquariums, etc.; ponds; lakes; fish farms; zoos; and the like that contain captive fish. The feeding water is selected from the group consisting of freshwater or saltwater or mixtures thereof.

As used herein, the term “frozen” refers to the solid, i.e., non-flowable, state of composition.

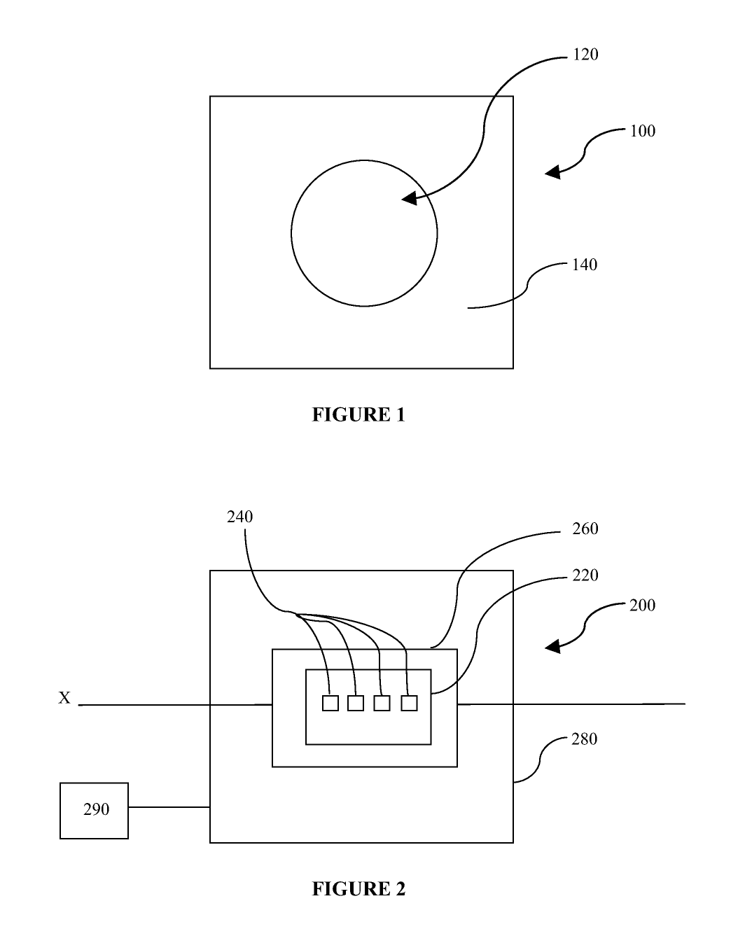

Described herein are frozen and/or gelled fish food products having an increased buoyancy. In accordance with all embodiments of the fish food products disclosed herein, the frozen and/or gelled fish food product contains at least one air cavity encompassed by a solid mass of frozen and/or gelled fish food composition. In various embodiments, the frozen and/or gelled fish food product contains at least one air cavity that is completely encompassed or surrounded by the solid mass of frozen and/or gelled fish food composition. Referring to FIG. 1, a cross-sectional view of a frozen and/or gelled fish food product 100 according to one exemplary embodiment is shown. The fish food product 100 includes an air cavity 120 that is completely encompassed or surrounded by a solid mass of frozen and/or gelled fish food composition 140. When the fish food product 100 is frozen and/or gelled, feeding water does not penetrate the at least one air cavity 120. Thus, the presence of the air cavity 120 reduces the overall density of the entire frozen and/or gelled fish food product 100 by maintaining the same volume of the frozen and/or gelled food, but at a lower weight because the weight of the air in the cavity is significantly less than the weight of the frozen and/or gelled fish food composition. In other words, the presence of the at least one air cavity 120 will lower the overall density of the frozen and/or gelled product 100 containing the fish food composition 140 compared to a product containing the same frozen and/or gelled fish food composition that does not have the at least one air cavity. The lower density of the frozen and/or gelled fish food product 100 containing the at least one air cavity 120 operates to increase the buoyancy of the frozen and/or gelled fish food products in feeding water as compared to a product having the same frozen and/or gelled fish food composition without the at least one air cavity. The increase in buoyancy, in turn, allows the frozen and/or gelled fish food 100 product to float higher and/or for a longer duration in the feeding water, as compared to a product having the same frozen and/or gelled fish food composition without the at least one air cavity. This increase in buoyancy is desirable for, among other things, feeding the fish that are not capable or willing to eat this food composition at or near the bottom of the feeding water.

In certain embodiments in which the fish food product 100 is frozen, the frozen fish food composition 140 that forms the product may begin to melt, i.e., change phases from a frozen solid to a liquid and/or a gel, in the feeding water after the frozen fish food product is placed in the feeding water. The frozen fish food composition will melt if the ambient temperature of the feeding water and/or any air in contact with the food composition is higher than the freezing point of the food composition. The time it takes for the frozen fish food composition to melt will vary depending on a variety of factors (e.g., temperature and pressure of the feeding water, composition of the frozen fish food product, etc.). As the frozen fish food composition 140 proceeds to melt, the feeding water may eventually penetrate through the frozen fish food composition to the at least one air cavity 120, thereby filling the at least one cavity with feeding water and altering the overall density of the frozen fish food product 100. Alternatively, or in addition, as the fish consume the fish food composition 140 of the fish food product 100, the feeding water will eventually penetrate and fill the at least one cavity 120 with feeding water (e.g., the fish will eat a hole through the frozen fish food composition that surrounds the at least one air cavity and, thus, penetrate the air cavity), thereby altering the overall density of the frozen fish food product. Consequently, once the feeding water penetrates the at least one air cavity 120 and affects the overall density of the frozen fish food product 100, whether by melting or by the fish consuming the product, the buoyancy of the overall frozen food product will be affected.

In certain embodiments in which the fish food product 100 is gelled, as the fish consume the gelled fish food composition 140, the feeding water will eventually penetrate and fill the at least one cavity 120 (e.g., similar to the frozen product discussed above, the fish will eventually eat a hole through the gelled fish food composition that penetrates through the fish food composition to the at least one cavity). Consequently, once the feeding water penetrates the at least one air cavity 120 and affects the overall density of the frozen fish food product 100, the buoyancy of the gelled food product will be affected. In certain of the preceding embodiments, the gelled food product may melt, thereby affecting the buoyancy of the overall gelled food product in the same manner as described above for the melting frozen product, if the temperature of the feeding water is higher than the gelation temperature of the gelled fish food composition. As used herein, the term “gelation” temperature refers to the maximum temperature above which the gelled fish food product will not form. In other words, the gelled fish food composition will “melt” into a liquid above the gelation temperature.

In accordance with certain of the preceding embodiments, the fish food products 100 disclosed herein include frozen fish food compositions, gelled fish food compositions, or both frozen and gelled fish food compositions. Thus, in certain embodiments in which the fish food product is both frozen and gelled, as the frozen fish food product unfreezes, the solid, frozen fish food composition will transition into a gelled fish food composition as long as the feeding water is above the gelation temperature, i.e., the solid, frozen fish food composition will “melt” and form the gelled phase of the fish food composition.

In accordance with one or more embodiments, the fish food composition used in the frozen and/or gelled fish food products disclosed herein includes, but is not limited to, fresh fish such as salmon, halibut, herring, cod, and the like; other types of fresh seafood such as shrimp (e.g., brine shrimp), krill, fish eggs, squid, etc.; beef heart; bloodworms; silversides; daphnia; plankton; algae; spirulene; gelatin such as beef gelatin, pork gelatin, and the like; vitamins; and water. The fish food compositions disclosed herein optionally may also include added fish oil such as salmon oil, herring oil, and the like; added fish meal, and starch. However, preferably, the fish food composition does not contain added fish oil, added fishmeal, or starch. In accordance with certain of the preceding embodiments, the fish food composition includes combinations, mixtures, or both combinations and mixtures of the different types of ingredients described above.

In one embodiment, the frozen and/or gelled food composition includes fresh fish, kelp, algae, shrimp, squid, clams, gelatin, vitamin mix, and/or water.

In accordance with one or more embodiments, prior to freezing the fish food composition to produce the frozen fish food products disclosed herein, the fish food compositions disclosed herein are liquids, at least a partially gelled composition, or combinations thereof. In certain embodiments, the at least partially gelled composition may be fully gelled. In accordance with one or more embodiments, the liquids, at least a partially gelled composition, or combinations of both liquids and at least a partially gelled composition can also include solid matter such as solid particles. In accordance with this and certain other embodiments, the fish food composition prior to freezing includes a dispersion or suspension of solid particles in a liquid phase. In accordance with certain embodiments, the fish food composition includes solid particles dispersed or suspended in at least a partially gelled phase. In certain of the preceding embodiments, the fish food composition includes a combination of the liquid and at least a partially gelled composition embodiments described above. In certain of the preceding embodiments, the fish food composition is a liquid or at least a partially gelled composition that includes solid chunks or cubes of food up to 2 mm³ in size. In certain embodiments, the solid chunks or cubes of food are substantially larger than the solid particles of a dispersion or suspension.

In accordance with all embodiments, generally the fish food composition is a free flowing liquid prior to gelling and/or freezing. This free flowing liquid, with or without the solid particles and/or chunks of food, has a viscosity ranging from 3 centipoise (cps) to 70,000 cps. For the fish food ingredients disclosed herein that are not initially in liquid form, the fish food ingredients are liquefied by any means known in the art, such as emulsification, high speed grinding, high speed shearing, and the like.

In accordance with the exemplary embodiments of the frozen and/or gelled fish food product disclosed herein and as discussed in greater detail below, the liquid or gel fish food composition is frozen and/or gelled in a manner that creates at least one air cavity encompassed or surrounded by the fish food composition. The presence of the at least one air cavity helps lower the overall density of the frozen fish food product. In accordance with one or more exemplary embodiments of the disclosed frozen and/or gelled fish food product, the overall density of the frozen and/or gelled fish food product, i.e., the frozen and/or gelled fish food composition that encompasses or surrounds the at least one air cavity, is less than or equal to the density of feeding water.

It should be understood that in certain exemplary embodiments the frozen and/or gelled fish food product includes two or more air cavities encompassed by the frozen and/or gelled fish food composition.. In such exemplary embodiments with multiple air cavities, each of the two or more air cavities may serve to collectively increase the buoyancy of the frozen and/or gelled fish food product. In such embodiments with multiple air cavities, if the frozen and/or gelled fish food product were to break apart into multiple pieces after placement in the feeding water due to the melting of the frozen and/or gelled fish food product or the fish consuming portions of the frozen and/or gelled fish food product, each of the multiple air cavities may serve to increase the buoyancy of the piece of the fish food product that encompasses each of them. In this manner, the frozen and/or gelled fish food product of such exemplary embodiments may be caused to float higher and for a longer duration in the feeding water, as compared to a product without internal air cavities, even when the frozen and/or gelled fish food product begins to break down into two or more discrete pieces.

In accordance with the preceding and other exemplary embodiments, the frozen and/or gelled fish food products comprise about 60% to about 95% of frozen and/or gelled fish food composition and the balance air, by volume. In other words, the volume of the at least one air cavity present in the frozen and/or gelled fish food product can account for about 5% to about 40% of the total volume of the frozen and/or gelled fish food product.

The present disclosure also provides methods for preparing the frozen and/or gelled fish food product having an increased buoyancy as disclosed herein. In one or more exemplary embodiments, the fish food compositions disclosed herein is prepared in accordance with the following multistep method. The larger solid fish food ingredients, such as the fresh fish are first optionally baked or cooked in some manner. The fish ingredients, which may or may not be baked or cooked, may then be subjected to grinding one or more times, thereby grinding the ingredients into small particles and/or liquefying the ingredients. The ground and/or liquefied ingredients may then be finely ground and/or dispersed, e.g., suspended and/or emulsified, in at least a portion of the water added to the composition. At this point, additional water and any remaining dry ingredients, e.g., vitamins, may be mixed in and/or dispersed with the composition. The dispersed composition may also be pasteurized. In one exemplary embodiment, the dispersed composition is heated to at least 160° F. for a sufficient amount of time to kill any microorganisms present in the composition, thereby sterilizing the composition. The pasteurization may occur concurrently with or following the mixture and/or dispersion of composition. For example, following the fine grinding, steam may be added along the water and any remaining dry ingredients that are to be mixed and/or dispersed into the composition. This mixing and/or dispersing in the presence of the steam may occur until the composition reaches at least 160° F. and is held for a sufficient amount of time to sterilize the composition.

In certain embodiments in which the liquid food composition is frozen, following pasteurization, the hot, sterilized composition is frozen in a manner that creates at least one air cavity in the final frozen food product. In accordance with this embodiment, the hot food composition may be allowed to cool prior to freezing in the manner described in greater detail below. In accordance with this embodiment, the food composition contains no more than about 95% water by weight of the total composition.

In accordance with other embodiments in which the food composition is gelled, a gelatin, such as a beef or pork gelatin, may be added to the hot food composition. For example, the gelatin may be added following pasteurization. In accordance with these embodiments, the food composition may be allowed to cool for a period of time, e.g., about 30 minutes, prior to the gelling and/or freezing of the food composition in the respective manners described below. In accordance with these embodiments, the food composition containing the gelatin is allowed to cool so as to allow the composition to thicken or at least partially gel before being gelled and/or frozen according to the respective manners described below. In accordance with this embodiment, the food composition contains no more than about 95% water by weight of the total composition.

Furthermore, in accordance with one or more exemplary embodiments in which the food product is frozen and/or gelled, the method for preparing the product includes adding a fish food composition to at least one sealable compartment of a cooling container. The fish food composition is selected from a liquid fish food composition, at least a partially gelled fish food composition, and combinations thereof. The fish food composition is added in an amount that does not fill the entire volume of the at least one sealable compartment. The sealable compartment is then sealed with the fish food composition resident therein. Because the entire compartment is not filled with liquid and/or a partially gelled fish food composition, air is present in the sealed compartment. The sealed compartment is impermeable to liquid or gel, such as the liquid or partially gelled fish food composition, and is also impermeable to gases, such as air. After the compartment is sealed, the cooling container is concurrently cooled and tumbled or rotated until the fish food composition freezes and/or gels to forms the frozen and/or gelled fish food products disclosed herein. The fish food composition may be tumbled around a single, fixed axis or it may be tumbled gyroscopically around more than one axis. In one exemplary embodiment, the cooling container spins around a fixed axis to jostle the liquid or gel fish composition contents at the same time that the liquid fish composition is freezing and/or gelling.

The makeup of the fish food composition and the temperature at which the fish food composition is tumbled determines whether the fish food product is gelled and/or frozen. If the food composition is tumbled and cooled at below the freezing point of the liquid and/or gel food composition, the food composition will freeze thereby resulting in a frozen fish food product. In certain embodiments in which the food composition is a gel and the tumbling and cooling temperature is below freezing, the resulting fish food product will be both frozen and gelled. If the temperature at which the food composition is tumbled and cooled is higher than the freezing point but lower than the gelation temperature, the food composition will gel, thereby resulting in a gelled fish food product.

In various exemplary methods, the cooling container is spun at speeds ranging from 15 rpm to 55 rpm. The resulting frozen and/or gelled fish food product comprises the frozen and/or gelled fish food composition encompassing at least one air cavity, and the overall density of the frozen and/or gelled fish food product is less than or equal to the density of feeding water.

The present disclosure also provides an apparatus for preparing the frozen and/or gelled fish food product having an increased buoyancy as disclosed herein. Referring to FIG. 2, a schematic view of one exemplary embodiment of an apparatus 200 for preparing the frozen and/or gelled fish food product is shown. In accordance with one or more exemplary embodiments, the apparatus comprises a cooling container 220 including at least one sealable compartment 240, a tumbling device 260, and a cooling device 280. The cooling device 280 may be adjusted to a temperature below the freezing temperature of the liquid or gel fish food compositions disclosed herein. In accordance with one embodiment, the cooling device 280 is a refrigerator or freezer, and the tumbling device 260 is located within the refrigerator or freezer. In various additional embodiments, the tumbling device and cooling device may be integral with one another and provided as a singular device. For example, the tumbling device 260 may comprise a rotating drum, the interior of which is subject to controlled refrigeration. In various exemplary embodiments, the tumbling device 260 is cylindrical in shape and has an inner cylindrical cavity large enough to accept the at least one cooling container 220. The cooling container 220, as disclosed herein, has at least one sealable compartment 240 that is impermeable to liquid and gas. Therefore, any liquid and/or at least partially gelled composition, such as the fish food composition disclosed herein, or gas, such as air, is trapped in the compartment when sealed. In various embodiments, the cooling container 220 may include a bank of generally uniform sealable compartments 240, each of which is adapted to receive fish food composition. During operation, each of the sealable compartments 240 of the cooling container 220 is at least partially filled with liquid and/or at least partially gelled fish food composition. The balance of the volume of the sealable compartments 240 is air (or, optionally, some other gas).

Also during operation, the cooling container 220 is placed in the tumbling device 260. In various additional embodiments, more than one cooling container 220 may be inserted into the tumbling device 260. In various additional embodiments, the cooling container 220 may be integral with the tumbling device 260. For example, the tumbling device 260 may include an interior that defines at least one sealable compartment for receipt of fish food composition therein. The inner cavity of the tumbling device 260 may be sealed. The tumbling device 260 spins the cooling container 220 around an axis “X” to agitate the cooling container and the contents thereof. Concurrently, with the tumbling or rotating of the cooling container 220, the contents of the cooling container are also being cooled. The fish food composition within the cooling container 220 may be cooled to below the freezing and/or gelation temperature of the liquid and/or at least partially gelled fish food composition. In accordance with the methods discussed above, the tumbling device 260 may spin at speeds ranging from 15 rpm to 55 rpm. However, the tumbling device 260 may spin at alternate rotational speeds in additional embodiments. As the cooling container 220 is tumbling or rotating, the fish food composition in the one or more sealed compartment 240 freezes and/or gels, thereby producing the frozen and/or gelled fish food products disclosed herein, i.e., a frozen and/or gelled fish food composition encompassing at least one air cavity and having an overall density less than or equal to the density of feeding water. The operation and performance of the cooling container 220, tumbling device 260, and/or cooling device 280 (e.g., sealing and unsealing of cooling container 220, rotational speed and duration of rotational cycle of tumbling device 260, operating temperature of cooling device 260, etc.) may be powered and controlled by one or more power unit and electronic controllers 290 (which may include, for example, one or more motor, transformer, motor starter, relays, fuses, switches, circuit boards, programmable controllers, etc.).

It will be understood that various changes may be made without departing from the scope of the invention, which is not to be considered limited to what is described in the description. While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Therefore, the inventive concept, in its broader aspects, is not limited to the specific details, the representative apparatus, and illustrative examples described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions--such as alternative materials, configurations, methods, devices and components, alternatives as to form, fit and function, and so on--may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

What is claimed is:

1. A fish food product having an increased buoyancy comprising:
a fish food composition selected from a frozen fish food composition, a gelled fish food composition, and combinations thereof;
an air cavity encompassed by the fish food composition; and
wherein the overall density of the fish food product is less than or equal to the density of feeding water.

2. The fish food product of claim 1, wherein the at least one air cavity is completely surrounded by the fish food composition.

3. The fish food product of claim 1, wherein the fish food composition is a frozen fish food composition.

4. The fish food product of claim 1, wherein the fish food composition is a gelled fish food composition.

5. The fish food product of claim 1, wherein the fish food composition is both a frozen and gelled fish food composition.

6. The fish food product of claim 1, wherein the fish food composition comprises ingredients selected from fresh fish, fresh seafood, beef heart, bloodworms, silversides, daphnia, plankton, algae, spirulene, gelatin, vitamins, and water.

7. The fish food product of claim 1, wherein the fish food composition comprises fresh fish, kelp, algae, shrimp, squid, clams, gelatin, vitamin mix, and water.

8. The fish food product of claim 1, wherein the fish food product comprises two or more air cavities.

9. The fish food product of claim 1, wherein the fish food product comprises about 60% to about 95% fish food composition, by volume, and about 5% to about 40% air, by volume.

10. A method for preparing a frozen fish food product having an increased buoyancy, the method comprising:
adding a fish food composition to at least one sealable compartment of a cooling container, the fish food composition is selected from a liquid fish food composition, at least a partially gelled fish food composition, and combinations thereof, wherein the fish food composition is added in an amount that does not fill the entire volume of the at least one sealable compartment;
sealing the at least one sealable compartment with air present in the compartment; and
concurrently cooling and tumbling the cooling container having the at least one sealed sealable compartment until the fish food composition freezes to form a frozen fish food product,
wherein the frozen fish food product comprises at least one air cavity encompassed by the fish food composition, and the overall density of the frozen fish food product is less than or equal to the density of feeding water.

11. The method of claim 10, wherein the at least one air cavity is completely surrounded by the fish food composition upon the forming of the frozen fish food product.

12. The method of claim 10, wherein the fish food product comprises two or more air cavities.

13. The method of claim 10, wherein the fish food product comprises about 60% to about 95% fish food composition, by volume, and about 5% to about 40% air, by volume.

14. The method of claim 10, wherein the step of tumbling the cooling container comprises rotating the cooling container around a single axis.

15. The method of claim 10, wherein the step of tumbling the cooling container comprises rotating the cooling container around more than one axis.

16. A method for preparing a gelled fish food product having an increased buoyancy, the method comprising:
adding a fish food composition to at least one sealable compartment of a cooling container, the fish food composition is selected from a liquid fish food composition, at least a partially gelled fish food composition, and combinations thereof, wherein the fish food composition is added in an amount that does not fill the entire volume of the at least one sealable compartment;
sealing the at least one sealable compartment with air present in the compartment; and
concurrently cooling and tumbling the cooling container having the at least one sealed sealable compartment until the fish food composition gels to form a gelled fish food product,
wherein the gelled fish food product comprises at least one air cavity encompassed by the fish food composition, and the overall density of the gelled fish food product is less than or equal to the density of feeding water.

17. The method of claim 16, wherein the at least one air cavity is completely surrounded by the fish food composition upon the forming of the gelled fish food product.

18. The method of claim 16, wherein the fish food product comprises two or more air cavities.

19. The method of claim 16, wherein the fish food product comprises about 60% to about 95% fish food composition, by volume, and about 5% to about 40% air, by volume.

20. The method of claim 16, wherein the step of tumbling the cooling container comprises rotating the cooling container around a single axis.

21. The method of claim 16, wherein the step of tumbling the cooling container comprises rotating the cooling container around more than one axis.
